(19) United States
(12) Patent Application Publication
(10) Pub. No.: US 2005/0172432 A1
(43) Pub. Date: Aug. 11, 2005

(54) Tool for cleaning taped seams of dry wall

(76) Inventor: Andrew J. Sullivan, Aberdeen, NJ (US)

Correspondence Address: Peter G. Thurlow, Esq., 326 South Pleasant Avenue, Ridgewood, NJ, 07450, US

(21) Appl. No.: 10/774,861

(22) Filed: Feb. 9, 2004

(51) Int. Cl. B05C 17/10

(52) U.S. Cl. 15/105; 15/235.4; 15/236.01

(57) ABSTRACT

A taping tool that includes a pole having a general U-shaped bracket at one end, a roller adapted to be connected to the general U-shaped bracket; and a general L-shaped bracket having a horizontal leg and a vertical leg. The horizontal leg includes openings for securing mechanisms to secure the general U-shaped bracket to the general L-shaped bracket, and the vertical leg includes openings for securing mechanisms to secure a blade to the general L-shaped bracket. The taping tool is used to finish taped seams by rolling the taped seam to evenly distribute the compound behind the tape and to set the tape in the seam, and using the blade to remove excess compound from the taped seam.

### BACKGROUND OF THE INVENTION

1. Field of the Invention

The present invention relates to the field of taping tools used in the construction industry for cleaning taped seams between adjoining wall boards.

2. Background of the Invention

Dry wall finishing is a trade that seals flat seams, inside and outside corners, bringing the sheets of dry wall up to paint-ready conditions. On a completed job, a person of ordinary skill in the art should not be able to detect any imperfections in the wall or ceiling after the paint has been applied. The process of sealing seams typically comprises at least three steps. In the first step (also known in the art as the first coat), a taper, i.e., a person with experience in the field of cleaning taped seams on dry wall, generously applies compound to the seam, and then covers the seam with commercial tape. The taper then uses a hand trowel (known in the art as a taper's finishing blade or cleaning blade) to remove the excess compound from behind the seam, and from behind the edges of the tape, all of this being done manually by the taper by continuously moving the hand trowel up, down, and across the taped seam, as necessary, to generally smooth the area on and around the tape. The taper then allows the tape and compound to dry for approximately 12 to 24 hours. In the second step (known in the art as the second coat) a second coat of compound is applied by a taper with a taper's finishing blade until there is a smooth finish. When done correctly, the seam is flush with the adjoining dry wall, and the seams and underlying tape are not recognizable. After another period of allowing the compound to dry, a taper will manually sand down any excess compound, and scuff up the dry wall surface in preparation for the third step (known in the art as the third coat or polishing step). In this step, the taper applies a thin layer of compound to fill in any hollow points or flake out any bumps in the dry wall. Additional sanding and final touch ups are then performed to ensure a quality job has been done. The inventor of the subject matter of this application has been working as a taper for the past twenty years and is cognizant of the numerous challenges a person of ordinary skill in the art faces when installing dry wall and cleaning taped seams. Although the description above of the three steps of finishing a dry wall seam has clearly been simplified, such steps, in practice, require significant skill and physical prowess to successfully complete a job.

A typical sheet of ½″ thick, 4′ by 8′ sheet rock weighs approximately 45 pounds and requires at least two individuals to install. On some construction jobs in commercial facilities, for example, several hundred sheets of dry wall may be installed. Due to the physicality of installing dry wall and finishing seams, various apparatuses have been designed and used in the past to make the taper's job easier. However, the apparatuses relating to the cleaning of the seam are overly complex, making them impractical to use on a job site, and consequently result in several tapers having to manually finish the taped seams. This lack of adequate apparatuses to assist tapers in doing their job leads to increased job costs because a significant amount of work still has to be done manually by the tapers.

A number of apparatuses have previously been designed that apply the compound and tape to the seam. For example, U.S. Pat. No. 3,625,798 (V. Ihli), title Taping Tool; U.S. Pat. No. 4,003,781 (Holsten), title Taping Gun; U.S. Pat. No. 4,996,941 (Mills), title Gypsum Wall Board Taping System; U.S. Pat. No. 5,114,527 (Stern et al.), title Drywall Tape Applying Tool; U.S. Pat. No. 6,367,534 B1 (McGlenn), title Pump Filled Drywall Taping Machines; U.S. Pat. No. 6,478,068 B1 (Brown), title Edge Taping Tool; U.S. Pat. No. 4,608,116 (Braselton), title Baseboard Edge Taping Tool; and U.S. Pat. No. 4,707,202 (Sweeny), title Tape Applicator, each generally describe apparatuses used to apply tape to a seam, or to apply tape in combination with compound to a seam. Although these patents do not teach or suggest an apparatus for cleaning a dry wall seam, such patents are instructive at least for understanding the process of initially filling the seam with tape and/or compound.

The most well-known apparatus in the art for simultaneously applying compound and tape is known as the “Bazooka”, so-called in the art because the apparatus actually looks like a Bazooka. The Bazooka revolutionized the taping industry, making the job more efficient and easier to perform because it was one of the first devices that effectively applied the compound and tape to a seam. However, even with the advent of the Bazooka, three tapers were still needed to complete a job—one taper, wearing stilts, would finish the seams on ceilings, around soffits, and the tops of the seams above 7-feet high; the second taper would complete the finish on the lower section of the wall; and the third taper would operate the Bazooka.

Carlson, in U.S. Pat. No. 4,592,797 (Carlson '797) and U.S. Pat. No. 5,545,287 (Carlson '287), tried to respond to the need to have an apparatus that effectively finished a seam, but Carlson's finishing tools, simply put, did not work. As shown in FIG. 1 of Carlson '797, Carlson's finishing tool is overly complex. It includes a curved trowel member (20), a roller (10) that comprises a plurality of cylindrical, relatively loose fitting, washer members (42—shown in FIG. 3), and a box scraper (24) that is apparently manually operated by a scraper actuating means (24). Due to the configuration of the roller, after rolling a section of a taped seam, the individual washers left individual impregnations in the compound and tape, which required tapers to follow the apparatus to smooth the finish. In addition, due to the loose fit of the washers, which became looser and looser as the apparatus was used, the individual washers would, in essence, “pinch” the tape and cause the tape to rip, again furthering the need for a taper to follow the tool to repair the ripped tape and to smooth the finish. Furthermore, the Carlson '797 apparatus was configured to finish a seam by first using a trowel, second a roller, and third a scraper box, in that order and only in that order. This design only permitted the scraper to go only as high up on the wall as the trowel could travel, thus leaving the upper section of the wall for a taper to manually finish. Many of the design problems in Carlson '797 were incorporated into Carlson '287 and consequently made the finishing tool in Carlson '287 impractical to use as well. As shown in FIG. 2, Carlson '287 is directed to a finishing tool (50), and includes the overly complex features shown in FIGS. 3, 3A, and 4 to finish a seam.

Thus, the prior art does not teach or suggest an easy-to-use taping tool for cleaning taped seams of dry wall.

### SUMMARY OF THE INVENTION

It is therefore an object of the present invention to provide a taping tool that is simple to use and practical taking into consideration common job-site conditions.

It is another object of the present invention to provide a taping tool that allows one taper to finish taped seams on a job including the lower and upper sections of the taped seams.

According to one aspect of the present invention, the taping tool includes a taping tool that includes a pole having a general U-shaped bracket at one end, a roller connected by a first securing means to the general U-shaped bracket, and a general L-shaped bracket having a horizontal leg and a vertical leg, where the horizontal leg includes openings for a second securing means to secure the general U-shaped bracket to the general L-shaped bracket.

According to another aspect of the present invention, the taping tool includes a pole having a general U-shaped bracket at one end, a roller connected by a first securing means to the general U-shaped bracket, and a general L-shaped bracket having a horizontal leg and a vertical leg. The horizontal leg includes openings for a second securing means to secure the general U-shaped bracket to the general L-shaped bracket, and a finishing blade includes openings at generally its base to receive a third securing means to secure the finishing blade to the vertical leg. The roller and blade are arranged on generally parallel vertical planes, generally opposed to each other.

According to yet another aspect of the present invention, the taping tool includes a pole having a general U-shaped bracket at one end, a roller connected by a first securing means to the general U-shaped bracket, and a general L-shaped bracket having a horizontal leg and a vertical leg. The horizontal leg includes openings for a second securing means to secure the general U-shaped bracket to the general L-shaped bracket. The vertical leg includes openings for a third securing means to secure a blade to the general L-shaped bracket, and the blade has a greater width than a width of said roller.

The above and other objects, features and advantages of this invention will be apparent to those skilled in the art from the following detailed description of illustrative embodiments of the invention, which is to be read in connection with the accompanying drawings, wherein:

### BRIEF DESCRIPTION OF THE DRAWINGS

FIG. 1 is a perspective view taken from one side of a taping tool constructed in accordance with the present invention;

FIG. 2 is a perspective view taken from another side of a taping tool constructed in accordance with the present invention; and

FIG. 3 is another perspective view taken from the front of a taping tool constructed in accordance with the present invention.

### DETAILED DESCRIPTION OF THE PREFERRED EMBODIMENTS

As mentioned above, the present invention is directed to a taping tool for cleaning seams formed when two dry wall boards are installed adjacent to each other on a wall or ceiling structure.

Initially, Applicant wishes to clearly define some of the terms used in the art. A “seam” is created when two wall boards are installed next to each other. Said seam is generally on horizontal or vertical planes but it may be on other planes as well. A “blade” is intended to mean a hand tool used to apply, spread, shape, or smooth compound in, on, or around a seam, and is also known in the art as a cleaning blade, finishing blade, or taper's knife. The word “generally” is intended to mean “in a general manner, in disregard of specific instances and with regard to an overall picture.” The word “base” is intended to mean “the lower part of an object, including, for example, the lower part of any support member or retaining member for the object.” The word “parallel” is intended to mean “extending in the same direction and not meeting,” where the distance between two parallel members may vary. The word “opposed” is intended to mean “to place generally opposite something.”

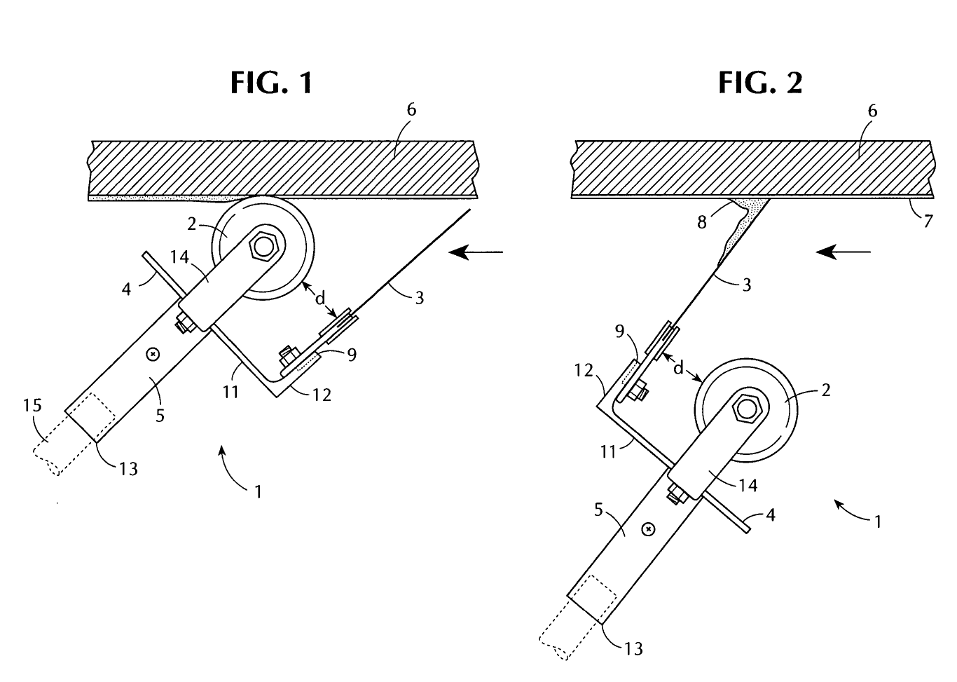

Referring now to the drawings in detail, and initially to FIG. 1, the taping tool 1 illustrated includes a roller 2, a blade 3, a generally L-shaped bracket 4 having a vertical leg 12 where the taper's blade 3 is attached and a horizontal leg 11 that is attached to the generally U-shaped bracket 14, pole 5, and related nuts and bolts to secure these components to each other. FIGS. 1 and 2 also illustrate the dry wall 6, tape 7, and compound 8.

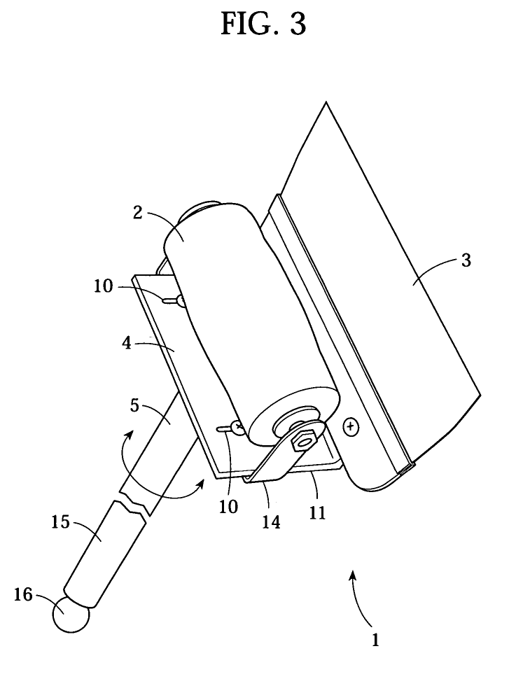

Taping tool 1 preferably includes a roller 2 (best seen in FIG. 3) that is a lathed, contoured piece of wood that is preferably 5-inches long, with a diameter of 2⅛″ at each end of the roller, and a gradual, increasing diameter towards the middle of the roller to 2¼″ at its center. The roller is drilled and tapped at each end, on its circular face. The resulting tapped hole accepts securing mechanisms such as, for example, through bolts from the connecting pole's U-shaped bracket to attach the roller to the pole, as described further below. Such securing mechanisms shall not impede the free rolling movement of the roller, in either the forward or reverse directions.

This preferred design is especially suited for cleaning vertical or horizontal wall or ceiling seams created when two 4-by-8 sheets of dry wall are installed adjacent to each other. When the roller 2 is used, its unique contour evenly distributes the compound behind the tape (the tape typically has a 2¼″ width) and effectively sets the tape into the seam, due to the diameter of the middle of the roller 2 being greater than the diameter at each end of the roller 2. Moreover, the unique contour allows each end of the roller 2 to roll over the edges of each side of the tape, thereby pushing out from under the tape the excess compound, creating excellent wipe-down conditions, preventing wrinkling or tearing of the tape, and preventing the formation of air bubbles under the tape.

The roller 2, as mentioned, is preferably a piece of wood having a solid core. The solid composition causes the roller 2 to roll smoothly over the tape and compound, thereby again preventing wrinkling or tearing of the tape. Preferably, the roller 2 is made of peach wood because the peach wood is light and durable. Other woods and materials of similar weight and wearing capabilities as the peach wood may be used for the roller. Also, a coat of polyurethane may be added to the wood to buttress its durability. In another preferred embodiment of the present invention, the size of the roller 2 can be reduced, for example, from 5″ to 2″, to allow the roller 2 to maneuver around pipes, electrical outlets, and soffits. In addition, the roller 2 may also have other shapes such as, for example, a roller may have a continuous diameter from one end of the roller to the other end of the roller such as, for example, 2⅛″, or a roller may have an increasing diameter from one end of the roller to the other end of the roller.

As seen in FIGS. 1-3, the roller 2 is attached to a U-shaped flat bracket 14 of the pole 5 by nuts, bolts, washers, and known in the art fasteners. When the roller 2 is secured to the bracket, the roller 2 spins freely and is not impeded by the bracket assembly or related securing mechanisms as the roller 2 rolls over the tape and compound on the wall. The U-shaped flat bracket 14 is connected to the pole 5 by known in the art securing mechanisms such as, for example, a male fitting on the pole and female fitting on the U-shaped bracket or preferably, by having vertical legs (one from each side of the middle of the U) extend from the bottom of the U-shaped bracket and into the inside of the pole 5. Such vertical legs preferably have openings to receive securing mechanisms such as, for example, bolts, screws, nuts, and washers that secure the vertical legs to the base of the pole 5. Moreover, on the side of the pole opposite the roller 2, the pole 5 preferably includes a female fitting 13 (interior threads not shown in FIGS. 1 and 2) at its other end, thereby allowing various extension poles 15, each having male fittings, to attach thereto. The various extension poles 15 may include 6′, 10′, or other sized poles, and may include poles having different shapes including poles having different angles such as, for example, a 30-degree angle, to finish seams in difficult to reach areas. Such pole extensions and their different shapes also allow one taper to finish the seams on the ceilings, around the soffits, and the tops of the seams above 7-feet high. In addition, as shown in FIG. 3, an extension pole 15 may include a circular-like ball 16 or similar attachment to readjust the position of the tape if, for example, the tape is improperly positioned on the seam by the person using the bazooka. The poles 5, 15 may also include comfort grips such as, for example, grips made out of neoprene-like material.

As seen in FIGS. 1 and 2, an L-shaped bracket 4 (90-degree flat-metal piece) is connected to the U-shaped flat bracket 14 several inches down from the roller 2. In other words, the horizontal leg 11 of the L-shaped bracket 4 is slid in between the roller 2 and U-shaped bracket 14. The horizontal leg 11 preferably includes slotted openings 10 to receive common securing means understood by those skilled in the art including nuts, bolts, or screws, to secure the L-shaped bracket 4 to the U-shaped bracket 14. When the L-shaped bracket 4 is secured to the pole 5, its horizontal leg 11 should have an adequate distance “d”, as shown in FIG. 1, between the roller 2 and blade 3, preferably 2¼″-2½″, so that the bracket 4 and blade 3 assembly do not impede the movement of the roller 2 as it rolls over the tape and compound on the wall, and to ensure that any compound buildup between the roller 2 and blade 3 does not adversely effect the operation of the taping tool. The slots 10 allow the distance “d” to be adjusted, based on the job being performed by the taper. As seen in FIGS. 1 and 2, the roller 2 and blade 3 are situated generally opposite of each other, on the same vertical plane, separated only by the distance “d”. Such structural arrangement allows the blade to be disposed so as to generally face the roller. This preferred design gives the taper the option of easily switching from using the roller 2 to using the blade 3, simply by rotating by 180 degrees the taping tool. With this preferred design, if a taper needs to spend more time rolling out a seam as compared to wiping down a seam with the blade 3, the taper can easily do so. Such design is in contrast to the Carlson tools discussed above, which have the trowel, roller, and scraper box immediately follow, in that order only, the Bazooka. The preferred design of the present invention also enables the taper to easily move the taping tool 1 back and forth, up and down, as needed, to clean the seam. In contrast, the Carlson tools can only move in one direction.

The vertical leg 12 of the L-shaped bracket 4 preferably includes slotted openings 9 to receive securing mechanisms known in the art such as, for example, bolts, screws, and nuts, to secure the base of the blade 3 to the vertical leg 12, with the base of the blade 3 preferably being situated on the inside surface of the vertical leg 12, closest to the roller 2 (as shown in FIGS. 1 and 2). The blade 3 will also include openings in its base corresponding to the openings in the vertical leg 12 to receive the securing mechanisms. With this preferred design, a taper can easily change the blade. For example, if the blade 3 gets damaged on a construction site, the taper can easily remove the damaged blade 3 and insert a new blade 3.

As seen in FIG. 3, preferably, the blade 3 has a width greater than the width of the roller 2. It is noted, however, that the width of the blade 3, like the size of the roller 2, may vary depending on the use for the taping tool. For example, the width of the blade 3 can be reduced, for example, from 8″ to 6″, to allow the roller 2 to maneuver around pipes, electrical outlets, and soffits. Preferably, the blade 3 is made of stainless steel because stainless steel has excellent wear and tear properties and the stainless steel is less likely to scar the dry wall as the taper finishes a seam. Moreover, preferably, the blade 3 includes a 90-degree angle at the edge of the blade 3 for removing the excess compound.

Although illustrative embodiments of the present invention have been described herein with reference to the accompanying drawings, it is to be understood that various changes and modifications may be effected therein by those skilled in the art without departing from the scope or spirit of this invention.

1. A taping tool comprising:
a pole having a general U-shaped bracket at one end;
a roller connected by a first securing means to the general U-shaped bracket; and
a general L-shaped bracket having a horizontal leg and a vertical leg,
wherein the horizontal leg includes openings for a second securing means to secure the general U-shaped bracket to said general L-shaped bracket.

2. The taping tool according to claim 1, wherein the vertical leg includes openings for a third securing means to secure a blade to said general L-shaped bracket.

3. The taping tool according to claim 1, wherein said roller has a solid core.

4. The taping tool according to claim 1, wherein said roller has an increasing diameter from the ends of said roller to a middle of said roller.

5. The taping tool according to claim 1, wherein said roller has a same diameter from one end of said roller to the other end of said roller.

6. The taping tool according to claim 1, wherein said roller has an increasing diameter from one end of said roller to the other end of said roller.

7. The taping tool according to claim 1, wherein an other end of said pole has a female fitting.

8. The taping tool according to claim 1, wherein an other end of said pole has a ball-like object connected thereto.

9. The taping tool according to claim 1, wherein the first securing means comprises through bolts connected to each end of said roller, the connection not impeding the movement of said roller.

10. The taping tool according to claim 1, wherein the second securing means comprises nuts, bolts, screws, and washers.

11. The taping tool according to claim 1, wherein the openings comprise slotted openings.

12. A taping tool comprising:
a pole having a general U-shaped bracket at one end;
a roller connected by a first securing means to the general U-shaped bracket;
a general L-shaped bracket having a horizontal leg and a vertical leg,
wherein the horizontal leg includes openings for a second securing means to secure the general U-shaped bracket to said general L-shaped bracket; and
a blade having openings at generally its base to receive a third securing means to secure said blade to the vertical leg, and
wherein said roller and said blade are arranged on generally parallel vertical planes, generally opposed to each other.

13. The taping tool according to claim 12, wherein said roller has a solid core.

14. The taping tool according to claim 12, wherein said roller has an increasing diameter from the ends of said roller to a middle of said roller.

15. The taping tool according to claim 12, wherein each end of said roller are drilled and tapped to receive the first securing means.

16. The taping tool according to claim 12, wherein the openings comprise slotted openings.

17. A taping tool comprising:
a pole having a general U-shaped bracket at one end;
a roller connected by a first securing means to the general U-shaped bracket; and
a general L-shaped bracket having a horizontal leg and a vertical leg,
wherein the horizontal leg includes openings for a second securing means to secure the general U-shaped bracket to said general L-shaped bracket,
wherein the vertical leg includes openings for a third securing means to secure a blade to said general L-shaped bracket, and
wherein the blade has a greater width than a width of said roller.

18. The taping tool according to claim 17, wherein said roller has a solid core.

19. The taping tool according to claim 17, wherein said roller has an increasing diameter from the ends of said roller to a middle of said roller.

20. The taping tool according to claim 17, wherein the first securing means, second securing means, and third securing means comprise through bolts, screws, nuts, and washers.
